(19) United States
(12) Patent Application Publication
(10) Pub. No.: US 2009/0265205 A1
(43) Pub. Date: Oct. 22, 2009

(54) Pricing, Allocating, accounting and distributing internal resources using a market mechanism

(75) Inventors: Kai H. Stinchcombe, Menlo Park, CA (US); Gregory Piesco-Putnam, Menlo Park, CA (US)

Correspondence Address: VAN PELT, YI & JAMES LLP, 10050 N. FOOTHILL BLVD #200, CUPERTINO, CA, 95014, US

(73) Assignee: IncentAlign, Inc.

(21) Appl. No.: 12/381,525

(22) Filed: Mar. 11, 2009

Related U.S. Application Data
(60) Provisional application No. 61/035,707, filed on Mar. 11, 2008.

(51) Int. Cl. G06Q 10/00

(52) U.S. Cl. 705/8

(57) ABSTRACT

A market based approach to allocating a resource within an organizational entity is disclosed. In some embodiments, a request comprising a bid indicating an amount of a purchasing power asset that a requester with which the request is associated is prepared to provide within the organizational entity to obtain the resource is received. The request is associated with a pool of competing requests for the resource, each competing request having associated with it a corresponding competing bid from a competing requestor from within the organizational entity. A winning bid is selected from the pool of competing requests. The resource is caused to be delivered to the successful bidder, and an accounting transaction is executed to charge the successful bidder an amount of purchasing power asset corresponding to a resource price. In some embodiments the price charged is an organizational entity-wide benchmark price, such as a market clearing price.

### CROSS REFERENCE TO OTHER APPLICATIONS

This application claims priority to U.S. Provisional Patent Application No. 61/035,707 entitled SYSTEM AND METHOD FOR PRICING, ALLOCATING, ACCOUNTING AND DISTRIBUTING INTERNAL COMPANY RESOURCES USING A MARKET MECHANISM filed Mar. 11, 2008 which is incorporated herein by reference for all purposes.

### BACKGROUND OF THE INVENTION

Typically, a division, unit, business, group of related or cooperating businesses, or other organizational entity acquires resources for the use of its personnel in performing tasks for the organizational entity. Examples include human resources, such as employees, contractors, and service providers contracted to perform defined services for compensation agreed upon between the service provider and the organizational entity; non-human resources, including raw or intermediate materials, components and subcomponents, or other factors of production; outsourced services such as copying and printing; purchased or leased equipment; and internally developed and/or created equipment, materials, tools, services, and the like. In many cases, such acquired resources are used within the organizational entity by multiple users, who compete within the organizational entity for such resources, for example in the budgeting, planning, and/or other internal decision making of the organizational entity.

### BRIEF DESCRIPTION OF THE DRAWINGS

Various embodiments of the invention are disclosed in the following detailed description and the accompanying drawings.

FIG. 1 is a block diagram illustrating an embodiment of a system for allocating acquired resources within an organizational entity.

FIG. 2A is a block diagram illustrating an embodiment of a process for acquiring resources.

FIG. 2B is a block diagram illustrating an embodiment of a market-based mechanism for allocating acquired resources.

FIG. 3 is a block diagram illustrating an embodiment of an auction platform system.

FIG. 4 is a block diagram illustrating an embodiment of an auction platform system.

FIG. 5 is a flow diagram illustrating an embodiment of a process for allocating acquired resources.

FIG. 6 is a flow diagram illustrating an embodiment of a process for facilitating definition of an acquired resource available for bidding.

FIG. 7 is a flow diagram illustrating an embodiment of a process for processing a received resource definition.

FIG. 8 is a flow diagram illustrating an embodiment of a process for processing a received resource request.

FIG. 9 is a flow diagram illustrating an embodiment of a process for conducting an auction to identify one or more winning bids for acquired resources of an organizational entity.

FIG. 10 is a flow diagram illustrating an embodiment of a process for detecting and responding to anomalous activity within an internal market for the acquired resources of an organizational entity.

FIG. 11 is a flow diagram illustrating an embodiment of a process for analyzing consuming user activity in an internal market for acquired resources.

FIG. 12 is a flow diagram illustrating an embodiment of a process for analyzing market-based competition for an acquired resource within an organizational entity.

FIG. 13 is a flow diagram illustrating an embodiment of a process for providing an interactive display associated bid amounts with corresponding wait times.

FIG. 14 is a flow diagram illustrating an embodiment of a process for providing an interactive display associated bid amounts with corresponding wait times.

FIG. 15 illustrates an embodiment of a bid submission mechanism.

FIG. 16 illustrates an embodiment of a bid submission mechanism.

FIG. 17 illustrates an embodiment of a bid submission mechanism.

FIG. 18 illustrates an embodiment of a bid submission mechanism.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered, or what is listed here as a single processing step may be divided and performed serially or two or more processing blocks illustrated here separately may be combined and performed in parallel or as a single step, within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A market-based allocation within an organizational entity of acquired resources of the organizational entity is disclosed. In some embodiments, a resource requester within an organizational entity submits a request for an acquired resource of the organizational entity. The request includes a bid indicating an amount of a purchasing power asset that the requestor is willing to provide in exchange for receiving the requested resource. The bid is compared with other bids, from competing requesters, to determine a priority of the requestor's request relative to the respective requests of the competing requesters. Requests are fulfilled in an order determined at least in part on the respective priorities unless/until a supply of the acquired resource is exhausted, in which cases requests associated with losing bids remain unfulfilled.

As used herein, the term “organizational entity” refers to any defined entity that acquires resources outside the organizational entity, for example on the open market, for use by personnel and/or other users of the organizational entity, and may include without limitation a business, governmental, non-governmental, or other entity; a division, unit, or other defined organizational subdivision of a business or other entity; and/or a group of businesses or other entities organized to operate at least in part in concert, including by acquiring resources for use by personnel of the combined and/or cooperating entity.

An “acquired resource” as used herein includes any resource, human or otherwise, acquired by an organizational entity from a source outside the organizational entity for use of the personnel and/or other users of the organizational entity. Examples include, without limitation, employees, contractors, or others retained to provide services within the organizational entity to personnel of the organizational entity, e.g., information technology (IT) support services; printing, word processing, administrative, and other support services; and non-human factors of production, for example particularly scarce and/or high value materials and/or components. An acquired resource may be purchased or hired in advance, for example on the open market, or contracted for in advance at a rate or other price agreed upon (or determined later in a manner agreed upon in advance) between an outside provider and the organizational entity. Once acquired, in the approach disclosed herein acquired resources become available to be requested by personnel or other users of the organizational entity for use within the organizational entity to perform and/or facilitate a task for the organizational entity. For example, IT services acquired by an organizational entity, by hiring IT staff and/or contracting for IT support services from a provider outside the organizational entity, are used by personnel of an organizational entity to ensure their computers are available to be used to perform work of the organizational entity. In the approach disclosed herein, a market-based mechanism is used to allocate acquired resources among personnel or other users of an organizational entity competing within the organizational entity for the use of such acquired resources, as described more fully below.

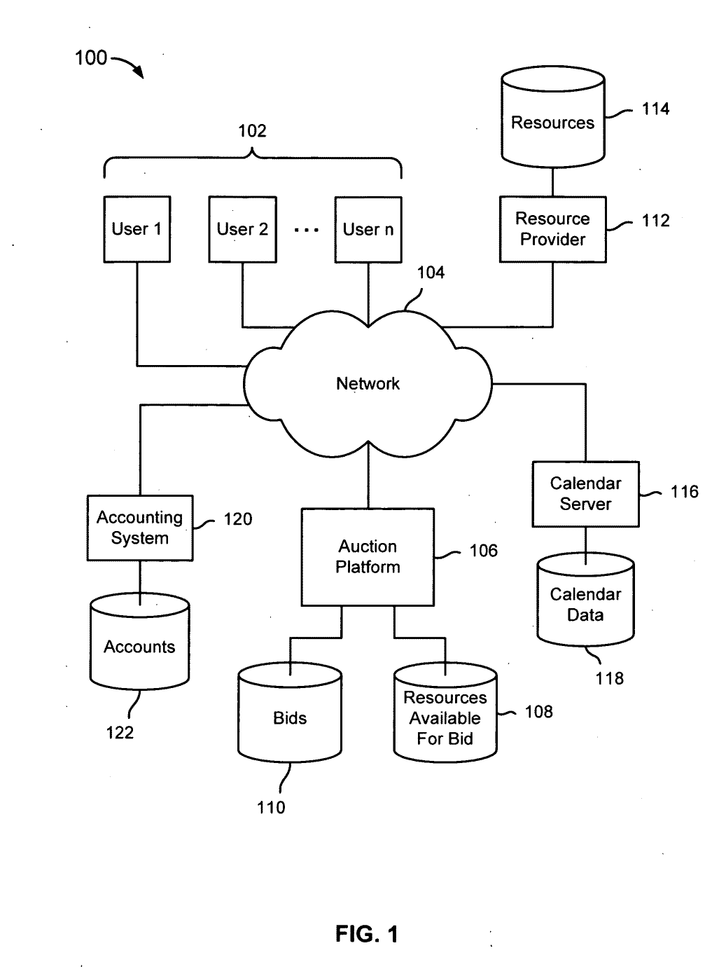

FIG. 1 is a block diagram illustrating an embodiment of a system for allocating acquired resources within an organizational entity. In the example shown, the system 100 includes a plurality of users 102, represented in FIG. 1 by user client computer systems 1 to n, connected via a network 104 to an auction platform 106. In various embodiments, the auction platform 106 includes one or more processors in each of one or more physical systems, each configured to perform all or part of the functions described herein. In the example shown, the users 102 have access via network 104 and auction platform 106 to a stored database of resources available for bid 108, e.g., a list of services or other resources defined by one or more resource providers within the organizational entity as being available for bid within the organizational entity. Users 102 submit to the auction platform 106, via network 104, bids for requested resources, which bids are stored in a bid database (or other data store and/or storage location) 110. While resource database 108 and bid database 110 are shown as separate structures in FIG. 1, in various embodiments one or both are internal to auction platform 106. Providers of acquired resources of the organizational entity, represented in FIG. 1 by resource provider 112, use resource data stored in a resource database 114 to define and send to auction platform 106 for addition to resources available for bid 108 one or more acquired resources available for bid. For example, an IT department (or contractor) coordinator may use resource provider system 112 and IT staff schedule and skill set information in resource database 114 to define one or more biddable services to be made available for bid by requesting users. For example, if one Unix™ server and two Microsoft Windows™ workstation technicians are scheduled to be available to perform work for the organizational entity in a given eight hour workday, resource provider system 112 could be used to define individual biddable services, such as eight one hour Unix™ server troubleshooting appointments, two four hour Windows system setup appointments, and sixteen thirty minute Windows help desk calls. Each of the services, e.g., each thirty minute Windows help desk call, would be “advertised” via the auction platform 106 to users 102 as being available for bid. For example, users 102 could query auction platform 106 to find a desired service or other resource and submit a request including a bid for the service.

In the example shown in FIG. 1, a calendar server 116 having access to stored electronic calendar data 118 is connected to network 104 and accessible to one or more of users 102, resource provider 112, and auction platform 106. In various embodiments, calendar data 118 is available via calendar server 116 to access information from electronic calendars associated with one or more of users 102 and service provider 112, e.g., to determine times when a particular requesting user is available to receive a requested service and/or to schedule the service for delivery, e.g., by doing one or both of inserting an associated appointment in the electronic calendar of one or both of the user 102 to whom the service is to be provided and a specific service provider, e.g., a technician, scheduled to perform the service for the user.

An accounting system 120 is connected to network 104 and manages a set of accounts 122. In some embodiments, each of the users 102 is allotted, for example in connection with a budget and/or other planning process of the organizational entity, an apportioned quantity of a purchasing power asset usable within the organizational entity to bid on acquired resources of the organizational entity. In some embodiments, allocations may be made to groups such as projects, product groups, teams, workforces, field offices, business units, divisions, etc., which may then create internal formal or informal policies for ensuring that an individual user does not over-spend the purchasing power asset. In various embodiments, the purchasing power asset comprises one or more of a budgeted amount of national currency; an internal “currency” denominated in the same units as the national currency; an internal currency denominated in fictitious units, such as “Organizational Entity Bucks”; and/or some other valuable asset of which the requesting user has a limited supply, such as a portion of what would otherwise be paid to the requesting user as a bonus. In various embodiments, a requesting user manages the user's supply of the purchasing power asset and uses same to compete and if successful pay for acquired resources. A user is prevented in some embodiments from placing a bid that exceeds the user's available supply of the purchasing power asset. In some embodiments, a user may be allowed to exceed the user's supply of the purchasing power asset and go into debt, but only to a limited amount. A user may be rewarded for not using too much purchasing power asset, e.g., the user may be given a prize, bonus, or other reward if they have purchasing power asset left over at the end of a month or other period. If successful, a requesting user's account is debited by an amount of purchasing power asset equal to a price charged for the service. In various embodiments, the price charged comprises one or more of the following: the price bid by the winning bidder to whom the service (or other acquired resource) is provided; the price bid by a highest unsuccessful bidder for the service (or other acquired resource); an average or other computed price that takes into account current bids and bids in one or more previous auctions of the same service (or other acquired resource); a benchmark price; a price determined at a future time; an average or other computed price that takes into account current bids and bids in one or more previous and/or future auctions of the same service (or other acquired resource); a market-clearing price; and/or one or more other market mechanisms. In some embodiments, the benchmark or other price that a successful bidder is to be charged for an acquired resource is determined at a time subsequent to the winning bid being selected and/or the acquired resource delivered, for example because bidding in a subsequent auction for the same resource is factored into the price, or because a post-auction evaluation is performed to determine if bids higher than a benchmark price were submitted due to an event or events resulting in scarcity and significant value being obtained by a successful bidder by virtue of having bid high, in which case a price higher than the benchmark may be appropriate, as opposed to the resource being bid up due to a chance occurrence, such as a number of requests typically made in the course of half an hour being submitted within a few minutes, in which case the benchmark price might be charged even though the winning and/or other bids were higher than the benchmark. In various embodiments, the price setting and associated accounting transactions, e.g., debiting a successful bidder's account, in some embodiments crediting a corresponding service provider's account, etc., are performed automatically, e.g., when the successful bid is identified (e.g., at auction time) and/or once the service or other acquired resource has been provided (e.g., fulfillment time).

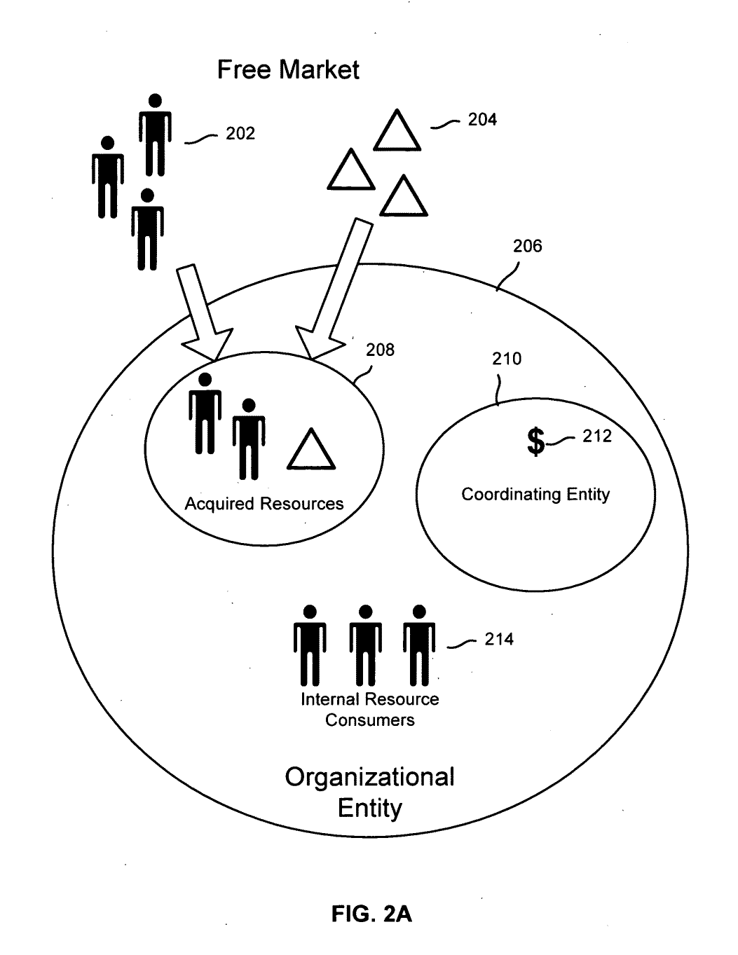

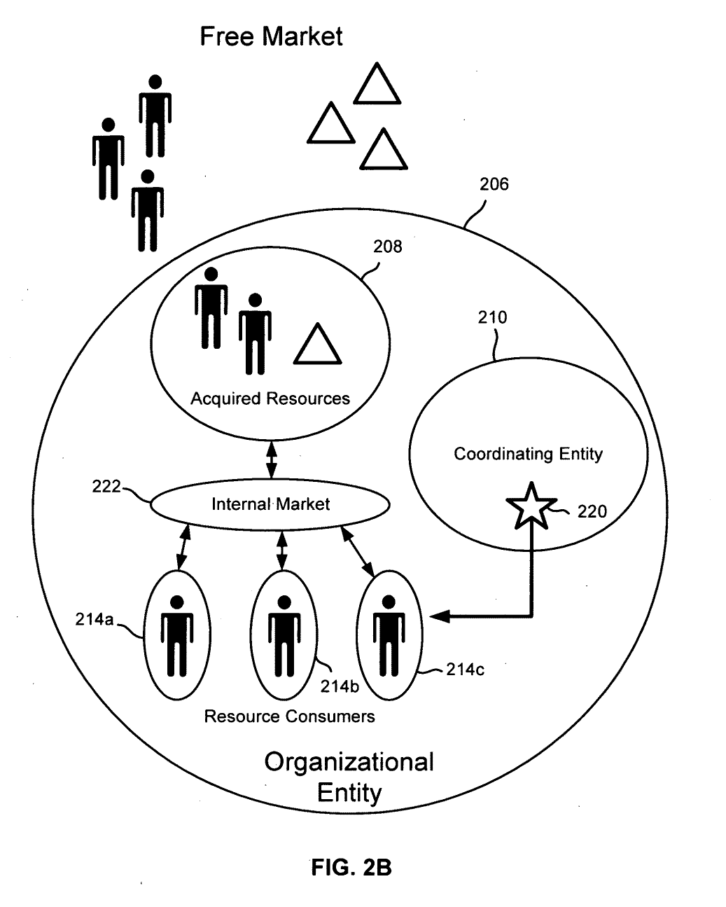

FIG. 2A is a block diagram illustrating an embodiment of a process for acquiring resources. In the example shown, human resource 202 and other resources 204 are shown as being available on the open market for acquisition. An organizational entity 206 competes in the free market with one or more other entities or other potential consumers of the resources 202 and 204 to acquire a set of acquired resources 208 of the organizational entity. As noted above, such resources may be acquired outright, e.g., by hiring an employee, purchasing or leasing equipment, contracting with an outside vendor to provide a service, or buying or contracting for material, etc. In the example shown, a coordinating entity 210 of the organizational entity 206 uses resources 212 of the organizational entity, e.g., cash or credit facilities, to acquire the acquired resources 208. Once acquired, the acquired resources 208 are available for use by internal resource consumers 214 of the organizational entity. Resource consumers 214 compete with each other within the organizational entity 206 for use of the limited acquired resources 208 of the organizational entity 206.

FIG. 2B is a block diagram illustrating an embodiment of a market-based mechanism for allocating acquired resources. In the example shown, each of competing resource consumers 214a, 214b, and 214c receives from coordinating entity 210 a respective budgeted and/or otherwise allocated amount of a purchasing power asset 220. Each competing resource consumer uses its allocated amount of the purchasing power asset 220 to compete in an internal market 222 to acquire resources included in the acquired resources 208 of the organizational entity 206. In various embodiments, the coordinating entity 220 apportions a respective amount of the purchasing power asset 220 to each resource consumer 214a-214c at the beginning of each fiscal year, quarter, or other period. In some embodiments, the coordinating entity 210 may allocate (additional) amounts to a resource consumer at other times, for example in response to a request for a further apportionment, upon determining that the consumer's legitimate and beneficial (to the organizational entity) been greater relative to competing users than anticipated, etc. In some embodiments, a resource consumer may have an opportunity to replenish its supply of purchasing power asset, e.g., by making a service or other acquired resource of the organizational entity that is under the resource consumer's control, e.g., a dedicated conference room or other facility, available to other resource consumers, e.g., for bid via internal market 222 and/or at a negotiated and/or predetermined price, thereby providing a mechanism for efficient reallocation of resources within the organizational entity.

In various embodiments, each of resource consumers 214a-214c submits for each resource required by that resource consumer a corresponding resource request indicating a bid representing an amount of the purchasing power asset 220 that the resource consumer is prepared to provide in exchange for the requested resource. In instances in which requests for a resource outstrip the immediately available supply, or in which a service or other resource must be provided over time to fulfill multiple competing requests, such that at least one or more requesters must wait for their request to be fulfilled, a market-based mechanism, such as an auction mechanism, is used to determine, based at least in part on the respective competing bids including in competing requests for the resource, which competing request(s) is/are fulfilled and, if applicable, in what order. In some embodiments, users may submit contingent or preferential bids; for example, they may place a bid for multiple interchangeable resources, e.g., two or more different conference rooms, so that if the first bid or highest preference bid is not high enough to schedule a first resource that is the user's first preference, the second preference bid or contingent bid is activated, increasing the likelihood that a suitable resource will be obtained, even if not the user's first preference. In some embodiments, a user can submit a bid, or multiple bids, such that if a first bid is not successful within and/or by a prescribed time a second, higher bid is activated (or a bid amount in the first bid is increased).

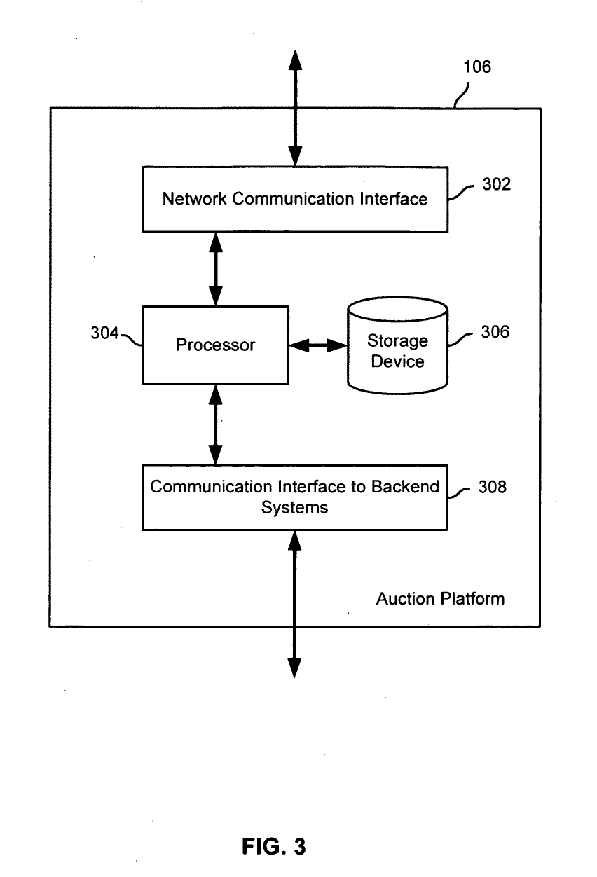

FIG. 3 is a block diagram illustrating an embodiment of an auction platform system. In the example shown, auction platform 106 includes a network communication interface 302, configured to enable one or more processes running on a processor 304 to communicate via a network, such as network 104 of FIG. 1, with one or more remote systems and/or processes running thereon, such as user systems 102 and resource provider system 112 of FIG. 1. In various embodiments, auction platform 106 comprises one or more physical computer systems and processor 304 represents one or more processors on each such physical system. Processor 304 is in communication with a storage device 306, such as a memory and/or a hard disk, flash memory, and/or other drive storage device. In various embodiments storage device 306 represents multiple devices located on multiple physical systems and/or devices internal and/or external to auction platform 106 and/or one or more physical computer systems comprising auction platform 106. A communication interface 308 to one or more backend system provides connectivity in the example shown to backend systems, such as accounting, scheduling, analysis, and/or business database systems, as described more fully below.

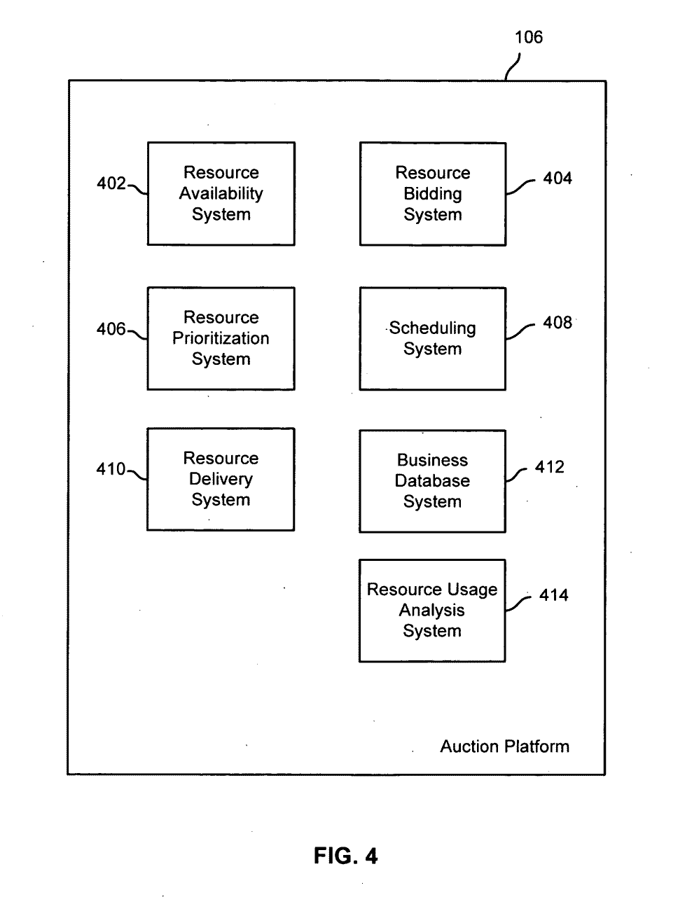

FIG. 4 is a block diagram illustrating an embodiment of an auction platform system. In the example shown, the auction platform 106 is shown as comprising a plurality of functional modules, denominated as “systems” in FIG. 4, each of which comprises a logical system residing on and/or accessible via a corresponding connector and/or interface on one or more physical systems comprising auction platform 106. In the example shown, auction platform 106 includes a resource availability platform 402, a resource bidding platform 404, a resource prioritization platform 406, a scheduling system 408, a resource delivery system 410, a business database system 412, and a service usage analysis system 414. The resource availability system 402 receives service or other resource definitions from resource providers and generates a list (or other data store and/or presentation) of what services and/or other acquired resources can be bid on, scheduled, or delivered to a requesting user. The resource bidding system 404 facilitates the submission of bids by requesting users, associates resource requests with corresponding resources and/or sets of resources, and associates resource requests with a pool of competing requests, if any, comprising requests that are competing to obtain the same resource. Resource prioritization system 406 determines for each competing request in a set of requests competing for the same resource a corresponding priority. In some embodiments, a requested resource or requested resources in a set is/are allocated to fulfill one or more requests having the highest priority. In some embodiments, if multiple competing requests can be fulfilled, they are fulfilled in an order determined at least in part on priority. Scheduling system 408 is configured to determine and use scheduling information to match resource requests with resources, for example by accessing the respective calendar of one or more of a requesting user and a resource provider. In some cases, a request may indicate times and/or days when the requesting user is available to have the requested service or other resource provided. In some embodiments a user may indicate in the requestor's electronic calendar, e.g., as an attribute of one or more events on the requestor's calendar, that the event can be interrupted or preempted to receive the requested service and/or other resource.

Resource delivery system 410 in various embodiments comprises human and/or automated processes for causing a service or other resource to be provided to a requesting user that has submitted a successful bid. The resource delivery system 410 may connect to the scheduling system 408 to add service deliveries to the calendars of service personnel (for example, trainers or lawyers) or related objects (facilities, equipment, software licenses, or other things) so they may be involved in the delivery of the requested service or other resource. The process that causes the service delivery may be active or passive; for example, it may send text messages to service providers, deliver emails, send computer-generated or pre-recorded telephone calls, use other business communication methods such as Nextel™ phones, or use other active processes; or it may rely on the service provider or service controller (e.g. the office manager of the office containing the conference room) checking the schedule of service or queue of services to be provided.

Resource delivery system 410 in some embodiments connects to business database system 412 to provide it with records of services performed and/or other resources delivered, for example duration or elapsed time, parts used, number of guests, or other information, for example to enable activity based costing. In the process of connecting to business database system 412 the resource delivery system 410 may be configured not only to debit the requesting user's business unit or individual account in an amount equal to a determine service or other resource price, but also to credit an account or expense report associated with a service provider, who may be another user within the organizational entity, with an amount that may be based on the requesting user's successful bid price, the services provided, a standard or variable percentage of the amount expensed to the requesting user, or any other set of factors.

Business database system 412 accepts data from the resource prioritization system 406 including the service or resource price to be charged to the successful requesting user (which may be denominated in any unit of value, e.g. dollars, shares, or a nonconvertible currency invented for the purpose of transactions within the delivery process; or related by a system of rates and scales to the actual service delivery, for example, $100 per hour or 1.25 times the standard hourly rate table) and service usage data about what exactly was bid for, as well as data including how, when, by whom, and for how long the service was actually delivered. These data streams enable the business databases system 412 to apply a numerical cost, in any of a plurality of units of value, to the transaction. The business databases system 412 in various embodiments includes any set drawn from a plurality of available human and software processes used to organize business-related information, for example, internal budgeting and accounting data, sales transactions, lists of employees and their divisions and roles, and IP or telephone number or extension assignment tables for company networks, and other general information. Examples of processes that track accounts and budgets are Quickbooks™, Microsoft Excel™, Oracle™, or PeopleSoft™; examples of processes that track employees are PeopleSoft™, Salesforce™, and EasyPay™; examples of general storage mechanisms are MySQL™. The elements of the business databases system 412 may already exist at the organizational entity or may be created, installed, or instituted in the process of creating the service delivery process. They include, in some embodiments, an accounting or budgeting mechanism that tracks or reports how expenses or resources are accrued, and contains business unit or individual accounts that expenses can be referenced to, and a budget administration system that, among other things, allows the values in these budgets or accounts to be read and/or modified; an employee database that may provide information about persons attached to or associated with the company; and another data storage mechanism that may store structured or unstructured data created by the service delivery process. The business databases system 412 accesses the various databases in some embodiments via business databases connectors that create or organize data streams or files so that they may be read to or from various business databases of the organizational entity. The user and/or service provider accounts in some embodiments do not maintain a running balance and instead budget codes or another tracking mechanism is used to generate an expense report. In some embodiments, the business database system 412 and/or associated accounts have associated therewith a balance below which the associated user is not permitted to run, in which case a bid price exceeding the amount in the applicable account may be rejected. In some embodiments, when the business databases system 412 has generated the numerical cost of the service or other resource, it causes a corresponding amount to be deducted from, added to, or indexed to, the appropriate business unit or individual account.

In some embodiments, the business databases system 412 provides information, for example to the resource bidding system 404, about who the user accessing the process is, what their roles and resources in the organizational entity are (for example, if they are a truck driver they may be guided to truck repair oriented services, while a sales agent may have a different set of available or recommended support services), and how much money or other internal purchasing power asset is available in their account, which may be used to limit their bid or simply to inform them of the amount to help them avoid an overrun or for any other purpose. It may also offer them the choice of expensing the service to one of several accounts they are entitled to draw from, for example, one of several projects they work on. The user may be identified based on login credentials including single-sign-in, referring URL, or cookies; IP address or phone extension or phone number; or other internal identifiers. The business databases system 412 provides appropriate data to the resource usage analysis system 414 to enable it to provide analysis to an authorized person or process.

In various embodiments, resource usage analysis system 414 allows authorized persons or processes to view aggregated resource usage or resource price data stored in the business databases system 412, alone or in combination with other data from the business databases system 412. The service usage analysis system provides a plurality of information to employees and managers, which may include, but is not limited to:

1. Real time pricing analysis—estimate the value of resources depending on the time of day and week, which can be used to schedule or reschedule shifts or allocate human or other resources for greater value;

2. Individual and organizational unit usage analysis—determine which organizational units or individuals are using a greater share of organizational entity resources, to address underlying causes or encourage reduced use;

3. Marginal pricing analysis—correlate the value of resources internally with external prices to provide a more valuable package of services and/or other resources to resource consumers at less cost to the organizational entity (for example, if telephone technical support is valued at $30 an hour in internal markets and costs $18 an hour to the company, while in-person technical support is valued at $50 and costs $62, the company would do well to increase the internal supply of telephone support relative to the supply of in-person support).

Information generated by the resource usage analysis system 414 may be used by managers for a variety of purposes, including scheduling and hiring staffers, rewarding or punishing employee behavior, analyzing strategic challenges or developing business processes, and incentivizing employee behavior changes by making them aware that this information is collected, and other purposes. In some embodiments, the resource usage analysis system 414 also provides analysis to the resource bidding system 404 to estimate the priority or response time that will result from a given bid, or what bid is required to achieve a given estimated response time, for use in a bid submission interface and/or associated mechanism, as described more fully below. In some embodiments, the resource usage analysis system can generate confidence intervals based on past data to estimate, for example, at a bid price of $50 what is the 95% confidence interval for the service or other resource delivery time.

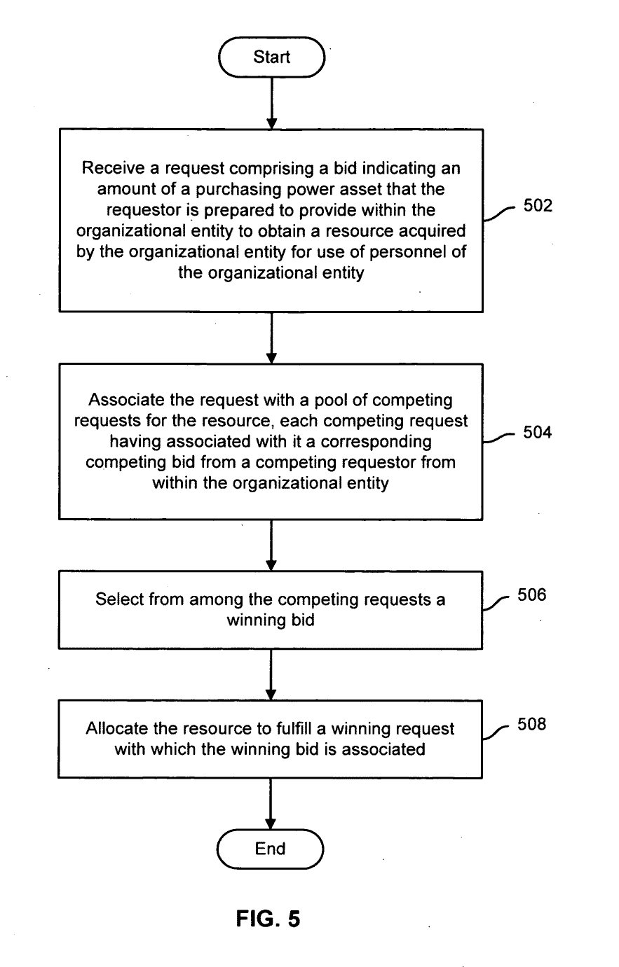

FIG. 5 is a flow diagram illustrating an embodiment of a process for allocating acquired resources. In the example shown, a request comprising a bid indicating an amount of a purchasing power asset that the requestor is prepared to provide within the organizational entity to obtain a resource acquired by the organizational entity for use of personnel of the organizational entity is received (502). The request is associated with a pool of competing requests for the resource, each competing request having associated with it a corresponding competing bid from a competing requester from within the organizational entity (504). A winning bid is selected from among the competing requests (506). In some embodiments, if sufficient resources are available to satisfy multiple competing requests, then multiple winning bids are selected. In some embodiments, if multiple requests can be satisfied over time by fulfilling requests serially, e.g., a single service provider, such as an IT technician or other employee or contractor fulfilling multiple requests in series, one after another, then a plurality of winning bids are selected and scheduled for fulfillment in an order determined based at least in part on the respective competing bid amounts, e.g., by fulfilling requests associated with higher bids sooner than those associated with lower bids. The requested resources are allocated to fulfill a winning request with which the winning bid is associated (508).

In various embodiments, upon fulfillment and/or scheduling for fulfillment an account associated with the requesting user is debited automatically in an amount representing a determined service or other resource price. In various embodiments, one or more auction or other market mechanisms are used to determine the price to be charged. For example, in some embodiments, a Vickrey auction is used. The number of simultaneous resource requests that can be met is determined. For example, if there are ten service employees on duty and each service request requires two employees, then five service requests can be met simultaneously. The requests associated with the corresponding highest number of requests, e.g., five the foregoing example, are determined and designated as the prioritized bids. For each of the prioritized (successful) bids, the resource price is determined to be equal to the bid price associated with the highest unsuccessful eligible bid.

Another available pricing process is the rolling Vickrey auction, which is a modified version of the Vickrey auction. In this approach, a set of bids beyond the set of currently competing bids is considered in order to set the resource price to be charged to successful bidders in a way that fluctuates less, or in a more predictable manner. For example, the resource price may be determined based at least in part on the average of the most recent five (actual or hypothetical) Vickrey auctions for resources of that type. The rolling Vickrey auction may combine or “roll together” bids that are alike in several different ways; for example, it may combine the five most recent bids for similar services, the five most recent bids for similar services on a similar day or at a similar time of day, etc.

Another method that may be used is the market-clearing auction. In that approach, the services or other resources that would be eligible over the course of the next Z number of hours is determined, and the Vickrey auction process is used to set the price for them all at once, and then schedule them as possible over the course of the next Z hours, for example in priority order based on their respective competing bids.

A fourth process to determine resource price to be charged is the first-price auction, which simply returns the highest bids as the prioritized service bids, each with its corresponding bid amount as the price charged to that requesting user.

While specific market mechanisms to determine the price to be charged to successful bidders are described above, in various embodiments any market mechanism that determines which resource requests have the highest priority and what the resource price should be charged to successful bidders may be used.

In some embodiments, the set of bids selected for a given set of interchangeable services or other resources is the set with the highest bid prices; or when services are not fully interchangeable, the set that maximizes the sum of the winning bids. This may not be the case in various other prioritization mechanisms. For example, a mechanism may give a bonus to some bids for reasons of having been placed earlier, leading earlier bids to win over later bids with higher bid prices. In another example, employees who usually bid low might see a priority boost to a high bid because it is more likely to represent a real emergency than the high bid of an employee who often bids high. In another example, a dual-trained employee (e.g. who can both respond to help desk tickets and configure new laptops) may be tasked to whichever service is most valued at that time. Extending that example, if the employee is more proficient in the former than the latter, a proficiency or goodness-of-fit factor may be introduced to represent the fact that the employee is likely to be more efficient or successful in the former task than the latter, and so as global value is maximized, unless the need for helpdesk-ticket-clearing is much less than the need for laptop-setup, he should be tasked with the former. In sum, the function of the bid amounts is generally to prioritize the service requests, but other factors may also be used.

In some embodiments, a value function that incorporates bid information and other factors is maximized to determine which requests will be fulfilled. For example, in the case of the dual-trained employee, or other dual-use resources, the value function may include one of more goodness-of-fit terms that bias results somewhat towards allocating resources to their best use. For example, a dual use resource may have a first benchmark price for a preferred or best use and a second, lower benchmark price for a lesser use, and the respective benchmark prices may be used in the value function to bias allocation of the resource to the preferred or best use. The value function may take into account other factors, such as differential use of collateral resources to fulfill one request as opposed to another (e.g., travel time and associated costs, such as fuel or travel allowances, that might have to be paid to dispatch a service provider to different locations to fulfill a request), and past experience or fit between a particular resource, such as a particular technician or other service provider, and a particular requester. For example, the value function may be biased to favor assigning a particular resource, such as a particular technician, to work on a particular piece of equipment that the technician has repaired successfully and/or to the satisfaction of the requestor in the past. In some embodiments, intangible and/or subjective factors, such as how difficult a particular requestor is to work with, which requesters have worked in the past successfully for a difficult requester, etc., may be taken into account by including a corresponding term in the value function. Other factors, such as penalizing aggregate wait time beyond some threshold or baseline, the criticality of external or internal customer relationships, etc., may be included, along with factors reflecting competing bids, in the value function. To select the requests that are to be fulfilled, the combination of winning bids that maximizes the value function is determined and those requests are fulfilled, which could result in one or more requests having bids that were lower than other, unsuccessful bid, being fulfilled.

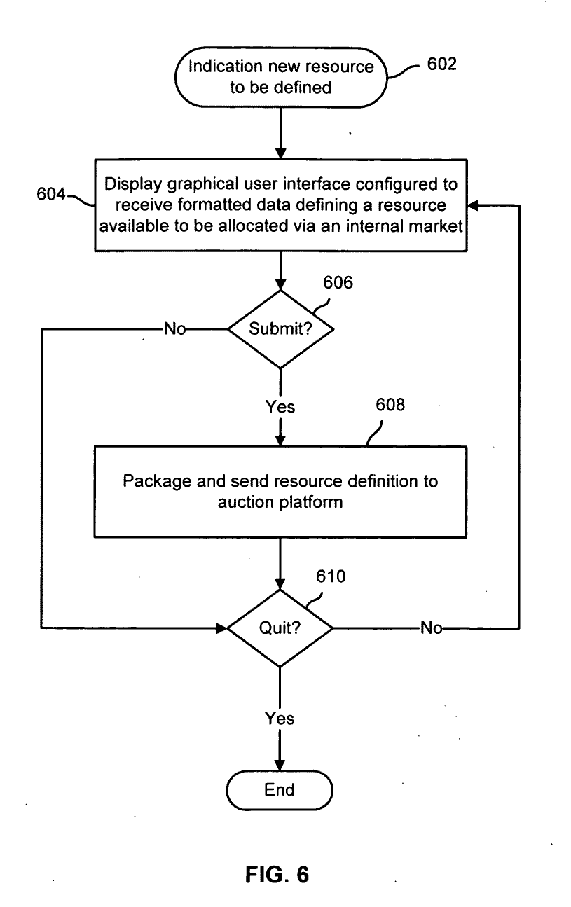

FIG. 6 is a flow diagram illustrating an embodiment of a process for facilitating definition of an acquired resource available for bidding. In some embodiments, the process of FIG. 6 is implemented on a service provider system such as service provider system 112 of FIG. 1. In the example shown, an indication that a new resource is to be defined is received (602), e.g., an indication that a “new” button or menu option has been selected in the context of a resource definition application, applet, and/or client. A graphical user interface (GUI) configured to receive formatted data defining a resource available to be allocated via an internal market is received (604). For example, a GUI having labeled text boxes, drop down menus, and/or other fields for providing formatted input, such as by identifying what service or other resource is available, at what time(s), under what terms, etc. In some embodiments, the GUI enables a resource provider to indicate a reserve price representing a minimum amount that must be bid and/or provided to receive the resource. In various embodiments, any data that may be required and/or helpful to enable interested users to locate and bid on the resource and/or to schedule, cause, and/or account properly for delivery of the resource to a winning bidder is solicited via the GUI. If the resource data is submitted (606), e.g., a “submit” button or other control or option is selected, the resource definition data entered via the GUI is packaged and sent to an auction platform for inclusion in a list or other set and/or database of resources available to be bid on (608). The process continues until the provider indicates the provider is done defining new resources (610), e.g., the resource definition interface is closed.

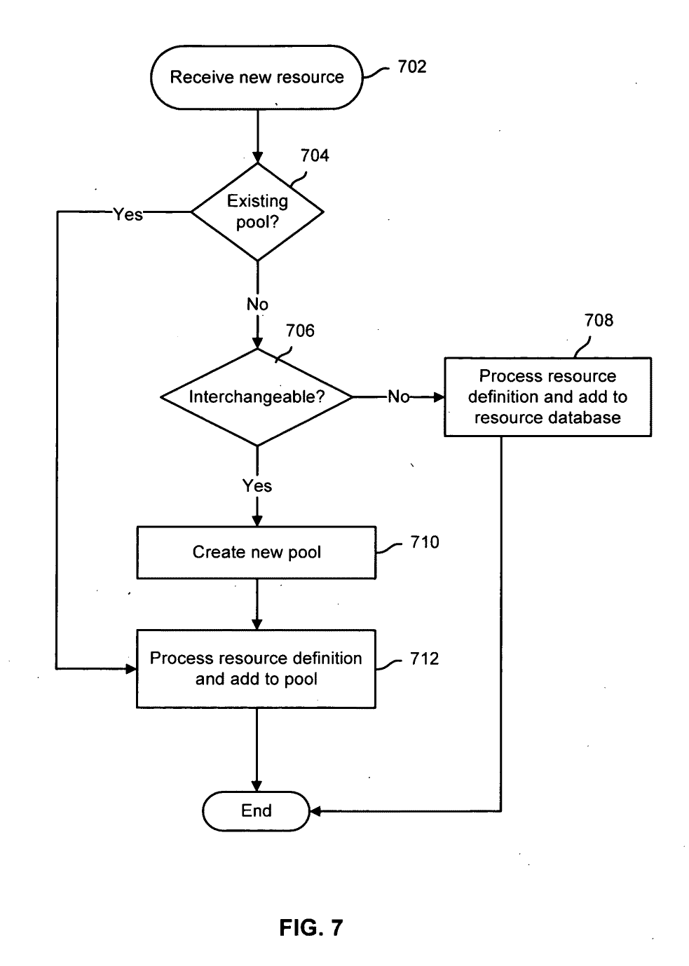

FIG. 7 is a flow diagram illustrating an embodiment of a process for processing a received resource definition. In some embodiments, the process of FIG. 7 is implemented by an auction platform and/or a component thereof, for example upon receipt of a new resource definition from a resource provider. In the example shown, a new resource definition is received (702). If the resource is associated with an existing pool of fungible resources (704), the resource definition is processed and added to the pool with which it is associated (712). If not (704), if the resource is interchangeable (or sufficiently nearly so) with one or more other resources (706), as indicated by the submitting resource provider, e.g., explicitly by selecting an option, setting a flag, or otherwise, or implicitly based on the resource class, identification, and/or description, or as determine otherwise by automated processing and/or human evaluation of the resource definition, a new pool is created (710) and the received resource definition (702) is processed and added to the newly created pool (712). If the resource is not interchangeable with other resources, the received resource definition (702) is processed and added to a list or other database of available resources as a single resource (708). In some embodiments, resources that share one or more prescribed attributes may be included in a pool of resources, despite being dissimilar in one or more respects. Other properties of the resource may be implicitly or explicitly specified, such as how finely it may be subdivided (it is appropriate to schedule a supercomputer in minutes or seconds, but for a person hours or half-days may be more appropriate) whether it can work on multiple tasks at once, its suitability for various tasks, etc.

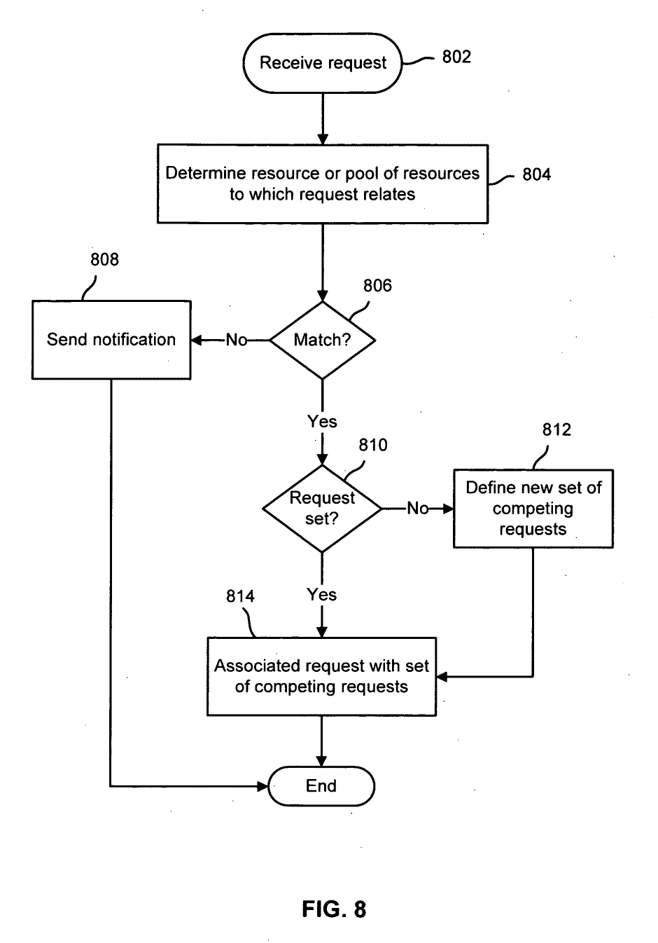

FIG. 8 is a flow diagram illustrating an embodiment of a process for processing a received resource request. In some embodiments, the process of FIG. 8 is implemented by an auction platform and/or a component thereof, for example upon receipt of a resource request from a resource consumer. In the example shown, upon receiving a resource request (802), a resource or pool of resources with which the request is associated is determined (804). In some embodiments, a request may be “matched” with a resource or pool of resources that are not identical to a resource described or otherwise specified in the request, for example by determining a next-best or closest fit resource. In some embodiments a user may be presented with an opportunity to indicate whether a next-best, closest fit, or other resource that is not an exact match with what the user requestor would be acceptable to the user. If the request is not determined to match any available resource or pool of resources (806), a notification is sent (808). If a match is found (806), it is determined whether the received request (802) is associated with an existing set of competing, e.g., other requests for the same resource. If not, a new set of competing resources is defined and associated with the resource and/or pool of resources with which the received request (802) is associated (804), and in either case the received request is added to the set of competing requests with which it is associated (814).

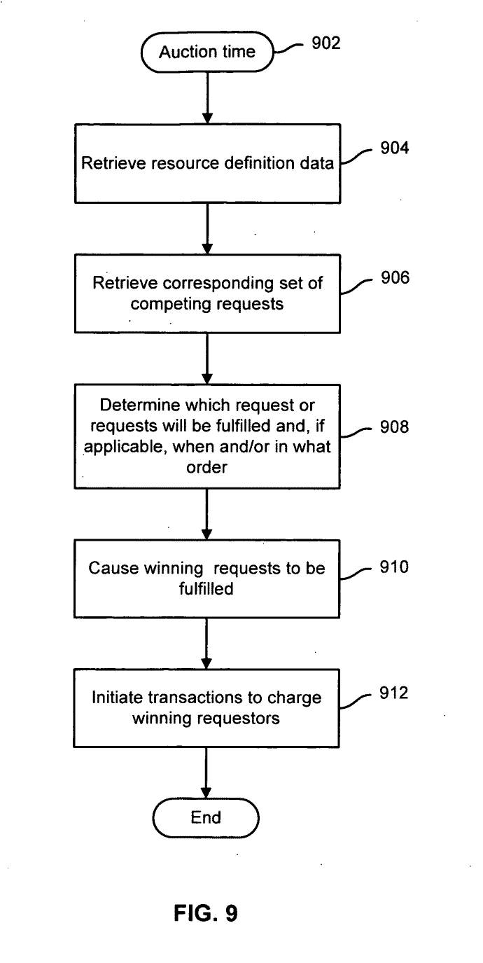

FIG. 9 is a flow diagram illustrating an embodiment of a process for conducting an auction to identify one or more winning bids for acquired resources of an organizational entity. In some embodiments, the process of FIG. 9 is implemented by an auction platform and/or a component thereof. In the example shown, an auction time is determined to have arrived (902). In various embodiments, one or more conditions may be evaluated to determine that the time to conduct the auction has arrived, including for example one or more of a scheduled time, a periodic time, a time indicated by the resource provider, and a time at which a triggering event has been determined to have occurred, or continuously. At auction time (902), resource definition data for the resource (or pool of resources) to be auctioned is retrieved (904). A corresponding set of competing resource requests are retrieved (906). It is determined which request or requests will be fulfilled and, if multiple requests are to be fulfilled an order in which they are to be fulfilled (908). In various embodiments, which request or requests are fulfilled is determined at least in part on the respective competing bid amounts. In various embodiments, respective competing bids may be weighted and/or incremented or decremented by amounts determined by such factors as how long the request has been pending without being fulfilled, how early in the bidding process the bid was submitted, etc. The requests selected for fulfillment are caused to be fulfilled (910). For example, an automated message or other data may be sent to a resource delivery or other system to cause the resource to be delivered to the successful bidder(s), e.g., for each at an appointed time and/or in an appointed order. Transactions are initiated automatically to charge each successful requestor a resource price to be charged for the resource (912). In some embodiments, the transaction results in a purchasing power asset account with which the user is associated, e.g., an individual account of an organizational unit account associated with a unit with which the requesting user is determined to be associated, e.g., through interaction with a business or other database of the organizational entity.

In some embodiments, the resource price charged to the successful requestor(s) comprises or is derived from an organization-wide benchmark price. The benchmark price may be determined in any suitable way believed to reflect the cost to the organizational entity of providing the resource to the successful bidder(s), the value provided to the successful bidders, and/or a price at which supply of the acquired resource is believed to be sufficient to meet demand for the resource at that price. In some embodiments, the benchmark price comprises or reflects a market clearing price. In some embodiments, a rolling organization-wide benchmark price is maintained and updated, e.g., by increasing the benchmark if recent bids have been higher than the benchmark and decreasing the benchmark if recent bids have been lower than the benchmark. The benchmark price is determined and/or updated prior to charging successful bidders, and all are charged the benchmark price, regardless of their individual successful bids.

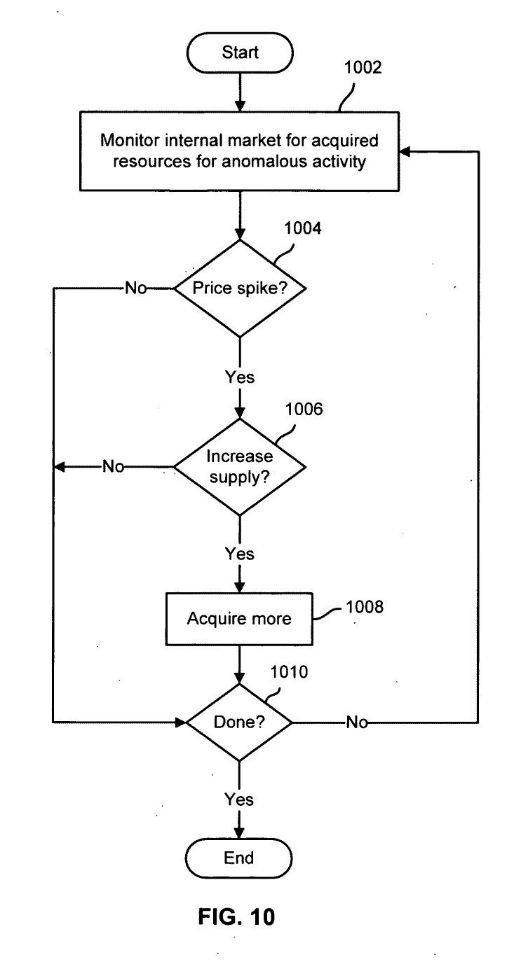

FIG. 10 is a flow diagram illustrating an embodiment of a process for detecting and responding to anomalous activity within an internal market for the acquired resources of an organizational entity. In the example shown, an internal market in which personnel or other human or other resource consuming users of an organizational entity compete for acquired resources of the organizational entity is monitored, e.g., by one or more automated monitoring processes (1002). If a “price spike” is detected (1004), for example, if bid prices are determined to exceed by a prescribed detection threshold a prevailing and/or historical market price for an acquired resource, it is determined whether the resource is one for which additional supply can be obtained (1006), for example, by calling in more workers, purchasing more of the resource on the open market, offering overtime pay or other incentives to workers able to supply the resource, etc., the more of the resource is acquired (1008) and made available to be acquired in the internal market. In some embodiments, a notification is sent, a report or report entry generated, and/or an event logged when anomalous activity is detected (1004). In some embodiments, anomalies other than price spikes, such as a markedly higher or lower volume of requests for a resource, may trigger responsive action. The process of FIG. 10 continues until an indication is received that monitoring is no longer required or desired (1010).

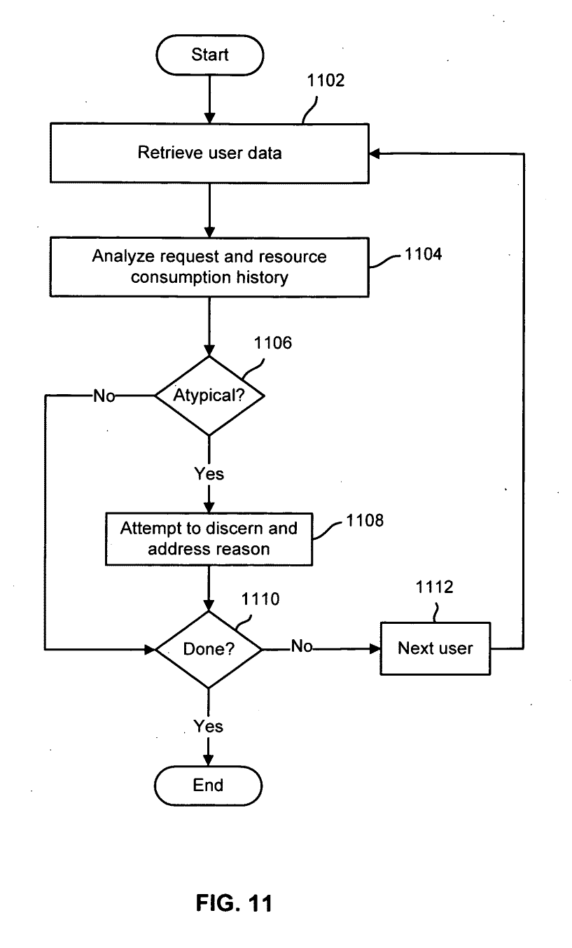

FIG. 11 is a flow diagram illustrating an embodiment of a process for analyzing consuming user activity in an internal market for acquired resources. In the example shown, a user's data is retrieved (1102) and the user's request (submitted bids) and resource consumption (successful bids) are analyzed (1104). If the user's behavior is determined to be typical of similarly situated users within the organizational entity (1106), processing continues with a next user (1112) or ends if there are not any further users to be evaluated (1110). If the user's behavior is determined to deviate in a predetermined manner from a relevant cohort (1106), then automated and/or human analysis is performed to attempt to discern why the user's behavior is atypical and to address, if appropriate and desired, any underlying reasons for such deviation (1108). For example, a user who has consumed an atypically high amount of an equipment repair service, or who repeatedly competes aggressively for such a resource, may be using an unreliable piece of equipment that should be replaced, or may simply be over-using the resource. For example, if the users of a given software program were responsible for 10% of the helpdesk tickets generated at a company, it might not be judged cause for concern; but if they were responsible for 30% of the urgent helpdesk tickets bid at over $100 an hour, it might indicate that the software often malfunctions in ways that significantly impair productive work. Conversely, a user who bids rarely or without success for a resource that other similar users consume more of may not be using enough of the resource to perform the user's function effectively, may not have been allocated sufficient internal purchasing power assets, or may simply have required less of the resource due to some other explanation that does or does not require intervention. By comparing individuals to groups, and groups to the whole, the effect of individual idiosyncrasies can be isolated (and, where appropriate, remediated or encouraged) and the effect of systematic factors can also be identified, and where appropriate, remediated or encouraged. The process of FIG. 11 continues until all users have been evaluated (1110).

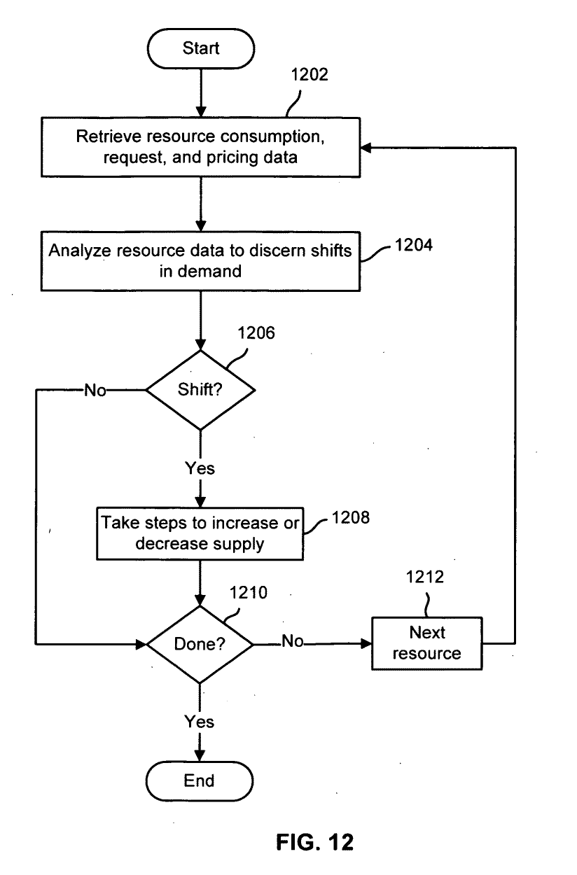

FIG. 12 is a flow diagram illustrating an embodiment of a process for analyzing market-based competition for an acquired resource within an organizational entity. In the example shown, resource consumption, request (bidding), and pricing data for an acquired resource of an organizational entity is retrieved (1202) and analyzed (1204) to determine long term shifts in demand. For example, bidding activity, including the number and frequency of requests, amounts bid, and amounts charged (price) to fulfill requests associated with winning bids are analyzed to determine whether the demand for the resource over a relatively long term has been much less than or conversely much greater than the available supply. If, for example, winning bids in recent quarters for a resource were much higher than a previously prevailing internal price for the resource, such a condition may indicate that long term demand for the resource has increased, such that actions should taken to increase supply, such as higher more people, contracting for more of a service, and/or otherwise acquiring more of the resource on the open market. Conversely, if fewer bids are being submitted and much lower bids being successful, and/or if units of the service or other resource are going unused (e.g., service provider or equipment down time), such a condition may indicate that the supply should be decreased, e.g., by furloughing excess providers; or selling, not replacing, and/or idling unused or underused equipment. If a shift is detected (1206), steps are taken to increase or decrease supply, as appropriate (1208). The process is repeated for each resource to be analyzed (1212) until all have been analyzed or analysis is terminated (1210).

In various embodiments, a bid submission interface is provided to consuming users to facilitate bid submission and informed decisions regarding what amount to bid. Current prevailing conditions in the internal market for acquired resources, e.g., the competing bids if any that have been submitted by other users, the number of units of a resource currently available to be auctioned, etc., and/or historical market data (e.g., past bidding and fulfillment results under market conditions similar to those prevailing currently) are analyzed to determine and display to a user preparing or contemplating a resource request a visual or other representation of data indicating to the user the expected or anticipated delay associated with potential bid amounts. In various embodiments, a single slider and/or other graphical user interface control or device is provided to enable a user to probe quickly a variety and in some embodiments a continuum of potential bid amounts to see the anticipated resulting wait time associated with potential bids.

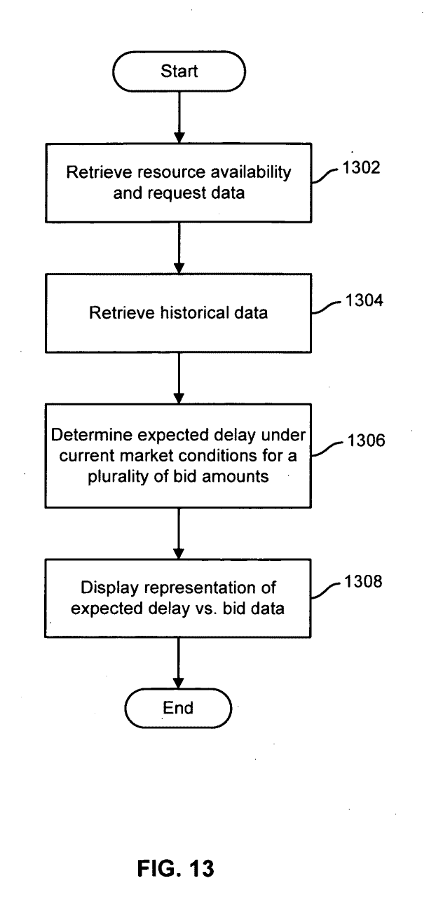

FIG. 13 is a flow diagram illustrating an embodiment of a process for providing an interactive display associated bid amounts with corresponding wait times. In some embodiments, the process of FIG. 13 is implemented on an auction platform and/or a component thereof, or an associated component. In the example shown, current resource availability and request data (1302) and corresponding historical data (1304) are retrieved. The anticipated wait time associated with each of a plurality of prospective bid amounts is determined (1306). The determined wait times are used in various embodiments to determine for a continuum of bid amounts, e.g., through interpolation or other techniques, a corresponding anticipated wait time. In various embodiments, one or both of stored current and historical bid data and associated wait times are accessed and used to determine for each of a plurality of bid amounts a corresponding likely wait time under current market conditions; and using one or more of interpolation, curve fitting, statistical learning, data mining, neural networks, and other numerical and/or statistical techniques to determine likely wait times for one or more of a continuum of bid amounts and a bid amount not included in said plurality of bid amounts.

Statistical techniques are used in some embodiments to estimate wait times with varying degrees of confidence, to enable users to choose, for example based on how critical it is to the user that the service or other resource be obtained within a particular time, how high a bid the user should submit to meet the user's needs and what degree of certainty the user requires. In some embodiments, calendar or other data associated with a particular requesting user may be used to determine likely delays, for example by factoring in periods of unavailability of the user to receive the service or other resource. For example, if a user has not indicated a high enough bid to receive a resource in the next two days and will be on travel for a week after that, the likely wait might jump from two to nine days, or conversely might flip discontinuously from nine days to two once a sufficiently high bid has been indicated. Or, if a user only has a one hour window available during the next 24 hours, the odds of the user receiving the resource within 24 hours for any given bid amount go down. In some embodiments, an IP address associated with a requesting user is used to identify the user and retrieve that requesting users calendar data to be factored into likely wait time, odds of fulfillment within a given period, and/or other computations. A representation of the likely (e.g., expected) delay (wait time) versus bid amount information is displayed to a consuming user (1308). In some embodiments, an interactive display and bid submission interface is displayed, which enables a consuming user to see the effect on anticipated wait time of increasing or decreasing a bid amount, or conversely to determine quickly an amount the user should bid to achieve a desired and/or tolerable wait time and a required or desired degree of confidence that the actual wait time will be the same as or sufficiently close to the anticipated wait time. In some embodiments, one or more variables other than and/or in addition to the likely delay are displayed, such as, confidence intervals, due dates, 90% due date, modal delivery time, median delivery time, expected delivery time, probability of delivery by a certain date, probability of delivery of a certain preferable quality of resource, probability of matching a resource that is only available for a limited time, probability that the first-choice bid rather than a contingent bid will prevail, etc. In some embodiments, a desired value for one or more independent variables may be set and a corresponding bid amount that the user should bid to the values indicated for such variables is displayed. In some embodiments, a graphical or other representation of price history is displayed, e.g., a benchmark price as it has changed over time. In some embodiments, a price spike or other notification of an anomalous market condition may be displayed, e.g., a notification indicating that due to a price spike (e.g., high bidding activity leading to high bid amounts, such as bid well above a benchmark price) only very high bids are likely to be fulfilled immediately.

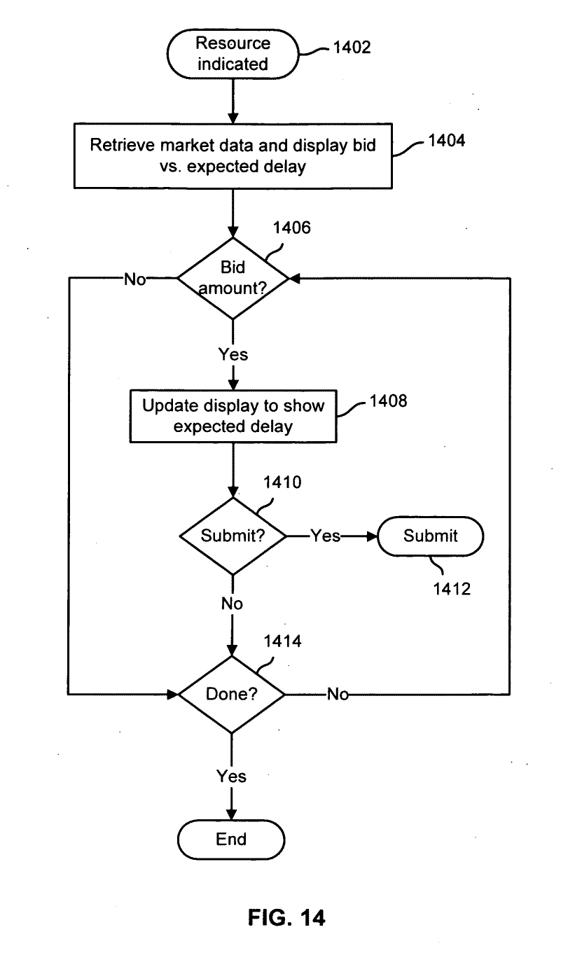

FIG. 14 is a flow diagram illustrating an embodiment of a process for providing an interactive display associated bid amounts with corresponding wait times. In some embodiments, the process of FIG. 14 is implemented on a consuming user's client computer system. In the example shown, a selection or other indication of a resource of interest is received (1402). Market data is retrieved and a representation of bid amount versus expected delay data is displayed (1404). If a prospective (or actual) bid amount is selected or otherwise indicated (1406), the display is updated to show a corresponding expected delay in receiving the resource (1408). In various embodiments, a control is provided to enable one or more variables other than bid amount to be varied, e.g., likely delay, expected delay, confidence intervals, due dates, 90% due date, modal delivery time, median delivery time, expected delivery time, probability of delivery by a certain date, probability of delivery of a certain preferable quality of resource, probability of matching a resource that is only available for a limited time, probability that the first-choice bid rather than a contingent bid will prevail, etc. If a “submit bid” or similar control is selected (1410), the bid is submitted (1412), e.g., by packaging and sending bid data to an auction platform. The display is provided and updated, as required, as the consuming user interacts with the display and until the consuming user indicates that the user is done (1414).

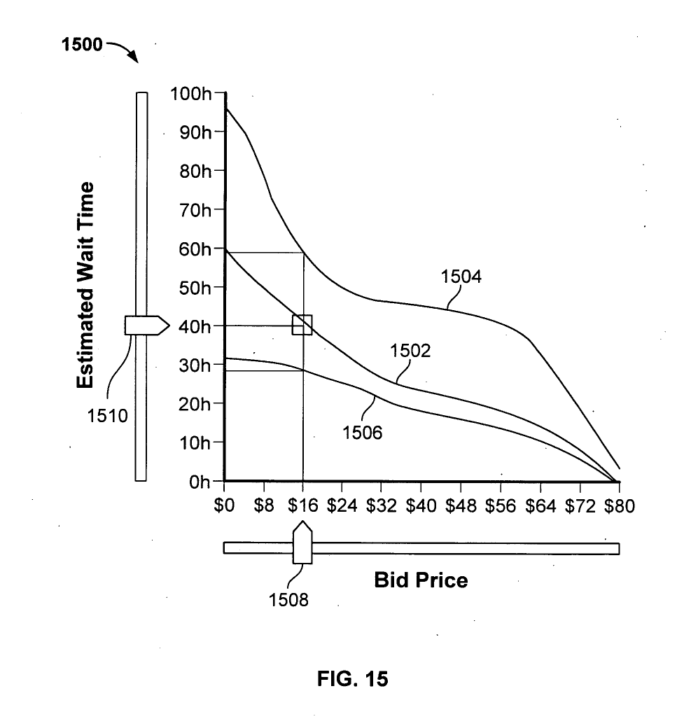

FIG. 15 illustrates an embodiment of a bid submission mechanism. In the example shown, a graphical user interface 1500 includes a display of three curves representing a middle (e.g., average) or most likely (1502), high or worst case (1504), or low or best case (1506) estimated wait time as a function of bid price. A bid price slider 1508 is configured to be manipulated by the user, e.g., by clicking and dragging the slider 1508 along the horizontal axis, to indicate a selected bid amount along a continuum (or a near continuum comprising many discrete points, e.g., in increments of $0.01) of potential bid amounts. As the slider 1508 is moved, the corresponding estimated wait time indicator 1510 moves accordingly to indicate the corresponding estimated wait times. In the example shown, the display indicates for the selected bid amount of $16.00 that the likely wait would be 40 hours, the worst case (within some degree of certainty) would be 60 hours, and the best case just under 30 hours. In some embodiments, the user can also drag slider 1510, indicating a desired estimated wait time, and the slider 1508 will move to indicate the price corresponding to that expected wait time.

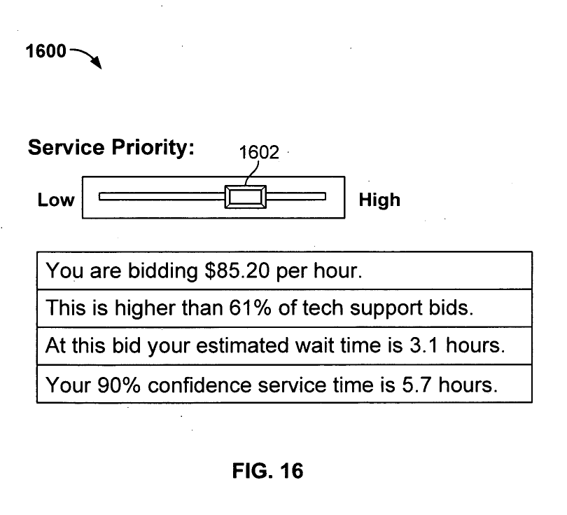

FIG. 16 illustrates an embodiment of a bid submission mechanism. In the example shown, the bid submission mechanism 1600 includes a single slider 1602 is shown, with qualitative extremes of “low” and “high” priority shown at either end. Text is shown indicating for a selected point along the slider what the bid amount, bid position relative to other bids, estimated wait time, and 90% service confidence time.

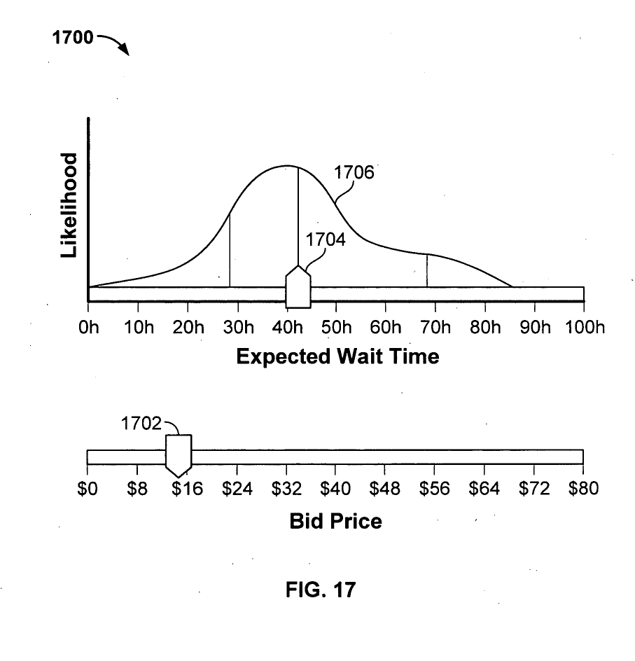

FIG. 17 illustrates an embodiment of a bid submission mechanism. In the example shown, the display 1700 includes a bid amount slider 1702 usable to indicate a bid amount of interest. An expected wait time pointer 1704 moves automatically in response to manipulation of the bid amount slider 1702 to indicate a corresponding expected wait time and a respective associated likelihood 1706 that the indicated average (middle, vertical line extending up from pointer 1704), worst case (vertical line to the right of pointer 1704), and best case (vertical line to the left of pointer 1704) expected wait time is what the user would experience if the user were to bid the amount indicated. In some embodiments, the user may also drag slider 1704 to select a desired most-likely or expected wait time, with slider 1702 moving to indicate the corresponding bid price.

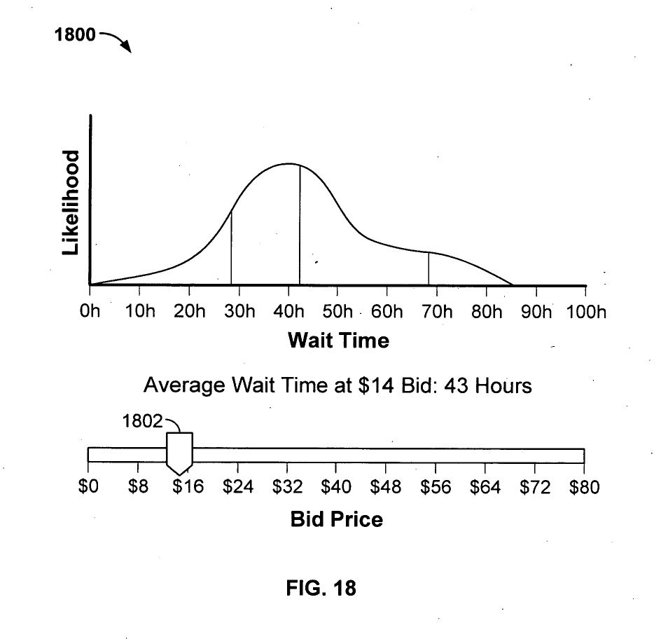

FIG. 18 illustrates an embodiment of a bid submission mechanism. In the example shown, display 1800 is similar to display 1700 of FIG. 17 except that in lieu of the pointer 1704 of FIG. 17 the display 1800 includes text indicating the average wait time associated with a bid amount indicated using bid amount slider 1802.

In some embodiments, market condition information and/or an interface to determine and submit a bid amount is provided via a telephone or other device; For example, in some embodiments a service bid telephone processor is accessed through a bidding user's telephone. The telephone processor is a commonly available combination of hardware and software that collects user input over a telephone connection (such as those used to check flight status or provide automated directory assistance), to which a user is able to make a telephone connection, and via which connection the processor is configured asks a series of questions or provides a series of prompts which may be responded to verbally or by using the buttons of a touch tone phone. For example, in this case, the telephone processor might be configured to prompt the user for a numeric or verbal entry representing which of the available types of service the user is requesting, and then might prompt the user for a numeric or verbal number representing the bid price, and then might give the user information about the estimated response time and offer the user a chance to revise their bid higher or lower. It might also be configured to offer the user a set of predefined priority levels, such as high priority, medium priority, or low priority; or offer the user the opportunity to state a service estimate deadline, such as “in four hours” or “Wednesday by noon”. It might also be configured to ask the employee to enter other information, such as a recorded description of the computer problem, their operating system, or the software they were using. The processor then is set up to create a data record based on the user's input. Multiple telephone lines and computers may be used together or in multiple locations to increase the capacity of the service bid telephone processor, or to allow different geographic subsets or divisions of the company to access the service through local extensions or numbers, or to provide a different interface for each of several services (for example, dial extension 7001 for computer tech support, dial 7002 to schedule a conference room).

In various embodiments, the communication to the user of the likely wait time corresponding the currently indicated bid amount is accomplished using text-to-speech technology or pre-recorded audio via a telephone, VOIP, or other audio voice interface. In some embodiments, the method of communication with the user comprises a telephone, VOIP, or other audio voice interface and speech recognition technology, enabling the user to indicate an amount verbally. If the amount communicated by the user is a bid amount, a corresponding likely wait time or set of likely wait times is communicated to the user, and the user is offered an opportunity to increase or decrease his bid amount based on the information just communicated to him. If the amount communicated by the user is a desired likely wait time, a corresponding bid amount is communicated to the user, and the user is offered an opportunity to increase or decrease his desired likely wait time based on the information just communicated to him.

In some embodiments, a continuum of priority, price, or rate levels is available to the user through the bidding mechanism. Other embodiments may allow only discrete points on the continuum, such as whole units of currency (e.g. $10.00 and $10.01, but no values in between), or only allocations represented by whole numbers of pixels on the screen of the interface, or, for convenience in the telephone interface, a smaller series of whole numbers—for example, those that can be answered in response to a prompt such as “Please use your keypad to enter a number from one to nine representing how urgent the service is, with one being most urgent and nine being least urgent. Lower numbers will receive quicker service, but will show up as more expensive in your monthly expense report. Please make your selection now.” The embodiment is expected to function best when users have the greatest flexibility in setting bids, but the system is fully able to comprehend a set of discrete possible values for user input rather than a continuum, such as when the user has only 100, 10, six, four, three, or two available priority levels.

In various embodiments, the bid and/or market condition interface and/or display may be presented via one or more devices, such as any personal computer, terminal, PDA, or other computer device capable of executing a program, i.e. displaying or communicating textual data and inputting the user's response, any device that allows two-way communication of voice-related data, including an voice over IP interface (“internet phone”) or a TDD. In some embodiments, the device has a data connection using any of a plurality of methods, such as an internet connection, a modem or telephone connection, a secure connection via SSH, HTTPS, or another secure protocol, a VPN connection, an intranet connection, an MPLS connection, direct wiring within a data center, or any other method that allows transfer of data.

In some embodiments, a resource bid client interface is loaded using a web browser. In some embodiments, a scheduling program (such as Microsoft Outlook™ Client) which has the ability to embed an external plug-in or module within its user interface is used to provide the resource bid client interface. The module may contain computer code representing the resource bid client interface or it may be configured to use a network or other connection to load the interface. Other examples include an independently executable program that embodies or loads the resource bid client interface, or a plug in to any other program such as Apple™ Concierge or Microsoft™ Add Printer Wizard that embodies or loads the resource bid client interface

While a number of specific graphical interfaces are shown in FIGS. 15-18, these are but a few examples of the limitless possibilities of how bid amount versus expected wait data may be displayed to a consuming user, in connection with a bid submission interface and/or otherwise. FIGS. 15-18 show slider controls, but any control configured to be positioned by a user to select a user-selected bid amount as the currently indicated bid amount may be used, including without limitation a linear slider control such as shown in FIGS. 15-18; a circular dial; and a pointer indicating a position on a curvilinear arc. Also, while FIGS. 15-18 show a graphical interface for providing bid amount versus expected or other likely wait data, the same information may be communicated to a user through any mode that can be perceived and understood by the user and which the device being used by the user to access the interface is configured to provide, including without limitation audio, voice, tones, vibration or other haptic output, or any other output or communication that the user perceives and understands to communicate the underlying bid amount versus likely wait, or other, information.

While certain embodiments described herein involve an internal market for acquired resources, an interface such as those shown and described in connection with FIGS. 13-18 above may be used to facilitate informed bidding to attempt to obtain resources other than the acquired resources of an organizational entity. For example, a service provider or other vendor may use the same or a similar approach to allow customers outside their organization to determine an amount to bid for a service or other resource to achieve the outcome the customer desires, e.g., 90% confidence that the service will be performed within 24 hours, likely or expected delay of X hours, etc.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method for allocating a resource within an organizational entity, comprising:
receiving via a communication interface a request, the request comprising a bid indicating an amount of a purchasing power asset that a requestor is prepared to provide within the organizational entity to obtain the resource; and
using a processor to:
associate the request with a pool of competing requests for the resource, each competing request having associated with it a corresponding competing bid from a competing requestor from within the organizational entity; and
select from the pool of competing requests a winning bid.

2. The method of claim 1, wherein the resource is created or acquired within the organizational entity and provided for the use of personnel of the organizational entity

3. The method of claim 1, wherein a requester with which the request is associated has a limited supply of the purchasing power asset available for use to acquire resources within the organizational entity.

4. The method of claim 3, further comprising allocating to each of a plurality of requestors a corresponding allocated amount of the purchasing power asset.

5. The method of claim 3, further comprising providing an incentive to conserve the purchasing power asset.

6. The method of claim 5, wherein the incentive comprises one or more of the following:
reducing a bonus to penalize use; and awarding a bonus or other prize or reward for success in conserving the purchasing power asset.

7. The method of claim 3, further comprising allowing a requestor to exceed the requestor's limited supply of the purchasing power asset by going into debt up to a limited amount.

8. The method of claim 1, wherein the bid indicates one or more of a price, a rate, and a priority level set by the requestor.

9. The method of claim 1, further comprising using the processor to allocate the resource to fulfill a winning request with which the winning bid is associated.

10. The method of claim 1, further comprising using the processor to debit an account associated with a winning requestor with which the winning request is associated.

11. The method of claim 10, wherein the account is debited in amount equal to one or more of the following: the amount of the winning bid; an amount of a second-highest bid; a highest unsuccessful bid; a market clearing amount; an amount that reflects an opportunity cost imposed on one or more losing bidders.

12. The method of claim 10, wherein the price debited for any member of a group of users of a resource at a given time is equal to a single benchmark price set for that group of users for that resource at that time.

13. The method of claim 12, wherein the benchmark price is set based on the lowest successful bid, or highest unsuccessful bid, among the group of users, in that period.

14. The method of claim 12, wherein the benchmark price for a given time is set not at that time, but some time after, allowing price or bidding behavior after that time to affect the price.

15. The method of claim 14, wherein the bidding behavior for a given resource around a is given point in time is grouped into at least two categories, among which are price fluctuations judged to have likely occurred by chance and price fluctuations judged unlikely to have occurred by chance, and in which the benchmark price is set differently for that resource at that time period based on whether the fluctuation is likely to have occurred by chance or not.

16. The method of claim 12, wherein in which a resource that can be used to fulfill multiple types of requests is assigned to fulfill a given type of request for a given time period based in part on the benchmark price for that request at that time being greater than the benchmark price of the other type of request which the resource could be used to fulfill.

17. The method of claim 10, in which the winning requestor is asked to select one or more accounts from the set of accounts from which the winning requester is entitled to draw purchasing power asset to acquire resources.

18. The method of claim 17, in which the winning requester is identified by a requesting IP address, a telephone extension, a telephone number, or other identifier available within the organizational entity.

19. The method of claim 10, in which the bid comprises a rate, further comprising tracking the activities of a provider of the resource in fulfilling the winning request, and determining an amount to be debited based on the winning bid, determined price, assigned price, or benchmark rate determined to be charged for the resource multiplied by a unit of services provided, such as the time spent by the provider to fulfill the request.

20. The method of claim 1, wherein the winning bid is selected based at least in part on the respective competing bids.

21. The method of claim 20, wherein the winning bid is selected based at least in part on a factor other than the respective competing bids.

22. The method of claim 20, wherein the winning bid is selected based at least in part on a priority associated with one or more of the respective competing requests.

23. The method of claim 20, wherein the winning bid is selected based at least in part on a duration of pendency of one or more of the respective competing requests.

24. The method of claim 1, wherein the request indicates one or more of the following: a time to fulfill the request; a range or list of times to fulfill the request; a preference regarding a time to fulfill the request; and an expiration time of the request.

25. The method of claim 1, further comprising using the processor to access an electronic calendar associated with a winning requestor with which the winning bid is associated and using availability data received from the electronic calendar to schedule delivery of the resource.

26. The method of claim 25, further comprising at least one of: a set of visual interface elements capable of allowing the user to designate certain calendar items or types of items as compatible with a given service request; a set of visual interface elements capable of allowing the user to designate certain calendar items or types of items as items that should be canceled in favor of a service request; or, a set of visual interface elements capable of allowing the user to designate certain calendar items or types of items during which a service request should not be scheduled.

27. The method of claim 1, wherein the resource is included in a set of interchangeable resources and the method further comprises receiving via the communication interface, from each of a plurality of requesters, a competing request for resources included in the set.

28. The method of claim 27, wherein each competing request includes zero or more fulfillment parameters indicating one or both of a time and manner in which the request is desired or required to be fulfilled.

29. The method of claim 27, wherein associating a received request with the competing pool of requests includes identifying the requests comprising the pool as capable of being fulfilled using resources comprising the set of fungible resources.

30. The method of claim 27, wherein selecting the winning bid comprises selecting from the competing pool of requests a set of selected requests such that a sum of bids associated with requests included in the set of selected requests is maximized.

31. The method of claim 27, wherein selecting the winning bid comprises selecting from the competing pool of requests a set of selected requests such that a value function, one component of which is the sum of bids in the set of selected requests, is maximized.

32. The method of claim 31, in which the value function additionally includes one or more of the following: travel time or cost; experience, training, or customer satisfaction measurements of the service providers in providing the services requested; cost to the company of the allocation of resources; estimated likelihood that the service provided will solve the problem satisfactorily; preference of the service provider; preference of the service requester.

33. The method of claim 31, wherein the value function includes a component that reflects a degree of fit between an assigned resource and a requested resource.

34. The method of claim 27, wherein each competing request includes a corresponding competing bid amount and selecting the winning bid comprises assigning to each of at least a subset of the competing requests a corresponding priority determined based at least in part on the respective competing bid amounts.

35. The method of claim 34, further comprising scheduling two or more of said subset of competing requests for fulfillment based at least in part on the respective assigned priorities.

36. The method of claim 1, wherein the purchasing power asset comprises one or more of the following: a quantity of money, a budgeted amount, a budgeted amount denominated in a national currency, an asset of value to one or more other requesters in the organizational entity, an asset usable by a holder to acquire a thing of value within the organizational entity, an internally defined asset allocable in discrete units, a portion allocated from a bonus or other compensation that would otherwise be due and paid to the requestor, and a private fictitious currency usable only within the organizational entity.

37. The method of claim 1, further comprising analyzing historical resource consumption and bidding data to detect long term shifts in demand.

38. The method of claim 37, further comprising increasing supply of the resource within the organizational entity if a long term shift in demand is detected.

39. The method of claim 1, further comprising detecting that one or more current bid amounts exceed by a predetermined amount a prevailing price for the resource, or that current bidding conditions are anomalous relative to historical resource consumption and bidding data.

40. The method of claim 39, further comprising taking a responsive action to increase supply in the short term based at least in part on detecting that said one or more current bid amounts exceed the prevailing price by the predetermined amount.

41. The method of claim 1, further comprising enabling a resource provider to indicate a reserve price representing a minimum amount that a winning bid must meet or exceed to obtain the resource.

42. The method of claim 1, wherein the bid comprises a first bid that is contingent on a second bid such that the first bid becomes active if the second bid is not successfully fulfilled or is not predicted to be successfully fulfilled by or within a prescribed time.

43. The method of claim 1, in which the bid amounts entered by users are subjected to a decay function or several decay functions that causes them to increase or decrease over time.

44. The method of claim 1, further comprising using bidding or resource use data to analyze employee behavior.

45. A system for allocating a resource within an organizational entity, comprising:
a communication interface configured to receive a request, the request comprising a bid indicating an amount of a purchasing power asset that a requestor is prepared to provide within the organizational entity to obtain the resource; and
a processor coupled to the communication interface and configured to:
associate the request with a pool of competing requests for the resource, each competing request having associated with it a corresponding competing bid from a competing requestor from within the organizational entity; and
select from the pool of competing requests a winning bid.

46. A system for allocating a resource within an organizational entity, comprising:
means for associating a request, the request comprising a bid indicating an amount of a purchasing power asset that a requester is prepared to provide within the organizational entity to obtain the resource, with a pool of competing requests for the resource, each competing request having associated with it a corresponding competing bid from a competing requestor from within the organizational entity; and
means for selecting from the pool of competing requests a winning bid.

47. A computer program product for allocating a resource within an organizational entity, the computer program product being embodied in a computer readable storage medium and comprising computer instructions for:
associating a request, the request comprising a bid indicating an amount of a purchasing power asset that a requestor is prepared to provide within the organizational entity to obtain the resource, with a pool of competing requests for the resource, each competing request having associated with it a corresponding competing bid from a competing requestor from within the organizational entity; and
selecting from the pool of competing requests a winning bid.
